(19) United States
(12) Patent Application Publication
(10) Pub. No.: US 2015/0134447 A1
(43) Pub. Date: May 14, 2015

(54) Wireless Communication System

(71) Applicant: CNNCTD, LLC, Southfield, MI (US)

(72) Inventor: Scott Schoeneberger, Commerce Township, MI (US)

(21) Appl. No.: 14/535,949

(22) Filed: Nov. 7, 2014

Related U.S. Application Data
(60) Provisional application No. 61/901,564, filed on Nov. 8, 2013.

(51) Int. Cl. G06Q 30/02

(52) U.S. Cl. CPC G06Q 30/0251
USPC 705/14.49

(57) ABSTRACT

A method and system for opening a marketing communication link is provided including an electronic device and a remote server. The electronic device may include a processor, a transmitter, a switch, a memory, a microphone, a speaker, and a device ID. The remote server may include a processor, a receiver, a transmitter, and customer contact information associated with the device ID. The method and system may execute an initiation phase, a prospect contact phase, and a communication link completion phase. Through use of the phases, a business may engage a prospective customer in a marketing experience at the prospective customer's discretion.

### CROSS-REFERENCE TO RELATED APPLICATIONS

This application claims the benefit of U.S. provisional Application No. 61/901,564 filed Nov. 8, 2013, the disclosure of which is incorporated in its entirety by reference herein.

### TECHNICAL FIELD

This disclosure relates to a wireless communication system for generating a marketing communication link between a business and prospective customer.

### SUMMARY

In one embodiment, a method of generating a marketing communication link includes receiving a prospect ID and a remote device ID and uploading the prospect ID and remote device ID to a remote server. The method also includes delivering the remote device to a prospect based on contact information associated with the prospect ID. The method further includes prompting the prospect to activate a transmitter of the remote device to transmit a notification signal to a receiver of the remote server. In response to receipt of the signal, the remote server transmits a prompt signal with the prospect ID to a representative and transmits a prompt signal to the remote device. In response to initiating contact with, and providing the prospect ID to, the representative and initiating contact with the prospect via the remote device, a communication link is opened between the representative and prospect.

In another embodiment, a remote device for generating a marketing communication link includes a processor in communication with a transmitter configured to communicate with a receiver of a remote server. The remote device also includes a remote device ID associated with a prospect ID including customer contact information and a switch in communication with the processor. The remote device further includes a memory including software instructions executable by the processor and configured to direct the transmitter to transmit a notification signal including reference to the remote device ID to the receiver of the remote server. The transmitter transmits the notification signal when the switch is triggered. The remote server transmits a prompt signal to the remote device and transmits a prompt signal to a representative to open a communication link between the customer and representative.

In yet another embodiment, a remote server for generating a marketing communication link includes a prospect ID including customer contact information and a processor in communication with a receiver and a transmitter. The processor is configured to handle an activation signal from a remote device to the receiver referencing a remote device ID associated with the prospect ID and to access the customer contact information. The processor directs the transmitter to transmit a prompt signal to the remote device and transmits a prompt signal to a representative to open a communication link between the customer and representative via the remote device.

In another embodiment, an electronic device for opening a marketing communication link between a marketer and a prospect includes a housing including a processor, a transmitter in communication with the processor and configured to communicate with a receiver of a remote server, a device ID associated with a prospect ID relating to the prospect receiving the device, a switch in communication with the processor, and a memory. The memory includes software instructions executable by the processor and configured to direct the transmitter to transmit a notification signal including the device ID to the receiver of the remote server when the switch is triggered such that the marketing communication link is opened between the marketer and the prospect. The electronic device may include a speaker and a microphone. The electronic device may include a receiver. The transmitter and receiver may be in communication with the microphone and speaker such that the communication link between the prospect and the marketer is facilitated by the electronic device. The housing may be a hand-held housing. The housing may have external surfaces suitable for printing of a marketing message.

In yet another embodiment, a remote server for opening a marketing communication link includes a receiver, a transmitter, a memory including a prospect ID including contact information of a prospect, and a processor. The processor is in communication with the receiver and the transmitter. The processor is configured to process an activation signal received by the receiver from an electronic device and including a device ID associated with the prospect ID. The processor is configured to access the prospect contact information and to direct the transmitter to transmit a signal to the electronic device based on the prospect contact information and to open a communication link between a marketer and the prospect. The processor may be further configured to transmit a prompt signal to a media device of the prospect based on the prospect contact information. The processor may be further configured to output media files accessible by the marketer and including marketing information relating to the prospect contact information. The processor may be further configured to receive a message from a network service provider for deactivation consideration of the electronic device associated with the prospect ID based on activity or inactivity of the electronic device. The processor may be further configured to communicate with a personal media device via a network such that a user may direct operations of the remote server.

In another embodiment, a method of opening a marketing communication link includes receiving a prospect ID and a device ID and uploading the prospect ID and device ID to a remote server. The method also includes delivering an electronic device to a prospect based on contact information associated with the prospect ID. The method further includes prompting the prospect to activate a transmitter of the electronic device to transmit a notification signal to a receiver of the remote server. In response to receipt of the signal, the remote server transmits a signal with the prospect ID to a marketer and another signal to the electronic device. In response to initiating contact with, and providing the prospect ID to, the marketer and initiating contact with the prospect via the electronic device, a communication link between the marketer and prospect is opened. The opening of the communication link may further include transmitting a signal to a media device associated with the prospect ID. The method may also include providing an opt-out or termination option for the prospect when the communication link is established. The method may also include delivering a message including the prospect ID to a network service provider for deactivation consideration based on activity or inactivity of the transmitter. The prospect ID may include prospect preference information stored as one or more digitally identifiable items. The prospect ID may be uniquely associated with the device ID. The electronic device may be delivered to the prospect as part of a three-dimensional mailer. The electronic device may further include a housing having external surfaces suitable for printing of a marketing message. The method may also include activating a light source or speaker to output a media signal in response to activating the transmitter of the electronic device. The opening of the communication link may include a theme selected to engage the prospect.

### BRIEF DESCRIPTION OF THE DRAWINGS

FIG. 1 is a schematic diagram showing components of a remote device and remote server;

FIGS. 2a and 2b are perspective views of a mailer according to one embodiment;

FIG. 3a is a flow chart showing steps of a method to generate a marketing communication link between two parties according to one embodiment;

FIG. 3b is a flow chart showing steps of a method to generate a marketing communication link between two parties according to one embodiment;

FIG. 4a is a flow chart of steps of a method to generate a marketing communication link between two parties according to another embodiment; and

FIG. 4b is a flow chart of steps of a method to generate a marketing communication link between two parties according to another embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ embodiments of the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular embodiments, applications, or implementations.

Businesses may desire to communicate marketing and advertising messages to current and prospective customers through various channels and mediums. Businesses may receive negative feedback if receipt of the marketing and advertising messages is unwanted and/or interferes with the intended recipient's schedule. For example, pop-up ads that interfere with web browsing and/or solicitation phone calls that interfere with personal time may dissuade a prospective customer from purchasing a good or service from the business. It may be desirable for businesses to engage a prospective customer in a marketing experience that is both enjoyable and at the customer's discretion.

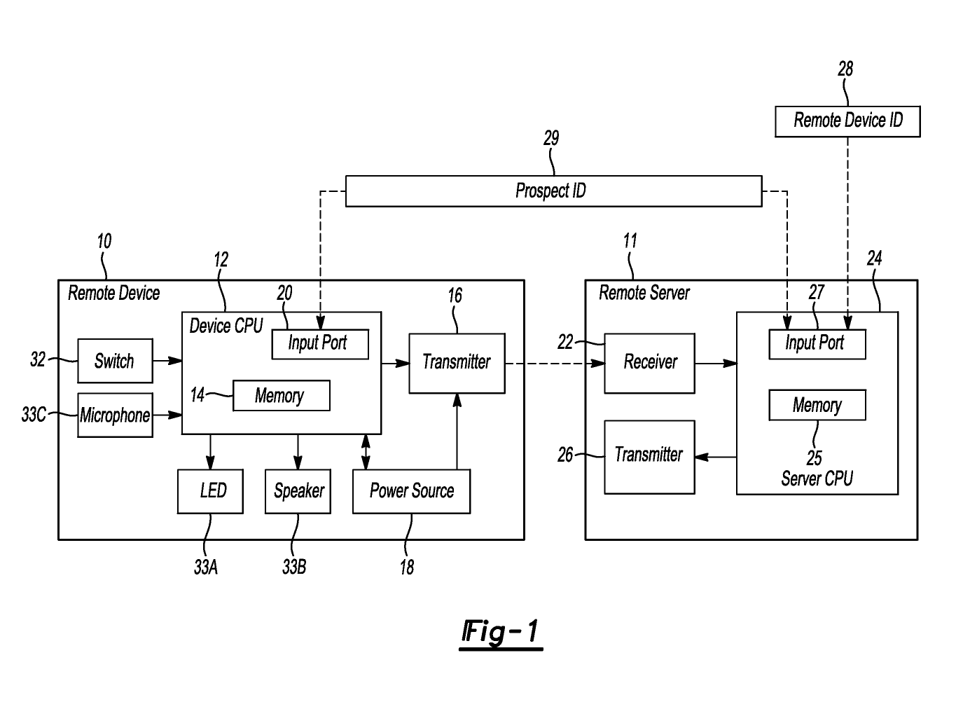

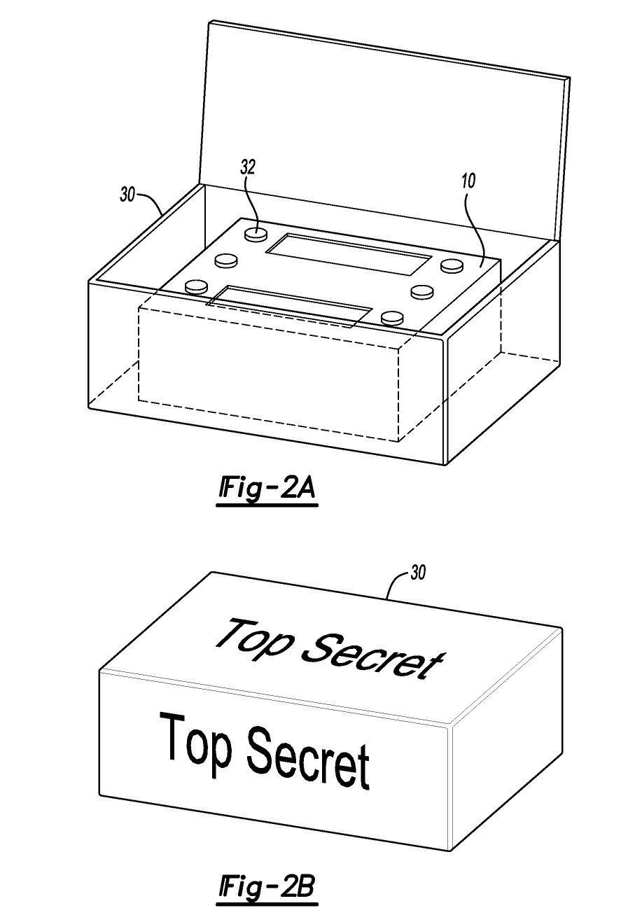

Now referring to FIGS. 1 through 2b, an illustrative remote device 10 and remote server 11 are shown. The remote device 10 and remote server 11 may operate together to facilitate a communication and/or transaction, such as generating a marketing communication link between a prospective customer and marketing entity. The remote device 10 may include a device computer processer unit (“device CPU”) 12 having a memory 14, a transmitter 16, and a power source 18. Various designs and sizes are available for the remote device 10. In one example as shown in FIG. 2a, the remote device 10 may be sized similar to a deck of cards and include a secret agent theme design described further below. In another example the remote device 10 may be sized similar to a pack of matches. In yet another example the remote device 10 may be embedded in a piece of cardboard or other paper marketing material. The device CPU 12 may direct operations of the remote device 10. The memory 14 may store data uploaded thereon via an input port 20 and may also include software operating instructions to assist in directing operations of the remote device 10. Examples of input port 20 may include a universal serial bus (“USB”) port, a mini USB port, a serial port, a fire wire port, and a pin. A receiver (not shown) may also be included to receive data transmitted wirelessly. The transmitter 16, such as a cellular radio, may transmit the information and/or data stored on the memory 14 via signals to a receiver of another device as directed by the device CPU 12.

For example, remote server 11 may include a receiver 22, a server CPU 24 having a memory 25, and a transmitter 26. The memory 25 may store data uploaded thereon via an input port 27 and may also include software operating instructions to assist in directing operations of the remote server 11. Examples of input port 27 may include a USB port, a mini USB port, a serial port, a fire wire port, and a pin. The remote server 11 may also be in communication with a personal computer via a network such that a user may direct operations of the remote server 11 and manually upload and manipulate data. Additionally, the receiver 22 may receive the signals from the remote device 10 and transfer the same to the server CPU 24. The server CPU 24 may execute functions relating to the data including data processing, sending the data to another receiver via transmitter 16, and/or storing the data for later access.

The remote device 10 and remote server 11 may be used to facilitate a marketing effort with a current or prospective customer also referred to as a prospect. In one example, a marketing entity, such as a vendor, may execute an initiation phase, a prospect contact phase, and a communication link completion phase. In the initiation phase, the vendor may obtain information about the prospect from a variety of channels including, but not limited to, prior vendor sales to the prospect. The prospect information may include customer contact details along with customer preferences related to vendor goods and/or services which may be compressed into one or more digitally identifiable items (collectively, a “prospect ID”). The prospect ID may include, without limitation, the prospect's first and last name, place of business, occupation, address, and contact number(s). The remote device 10 may include a remote device ID 28 which may be associated with a prospect ID 29. The prospect ID 29 may be uploaded to the server via input port 27. Optionally and/or alternatively, the prospect ID 29 may be uploaded to both the remote device 10 via input port 20 and to the remote server 11 via input port 27. The remote server 11 may store the remote device ID 28 and prospect ID 29 on memory 25 to access when the remote device 10 is activated as described further herein.

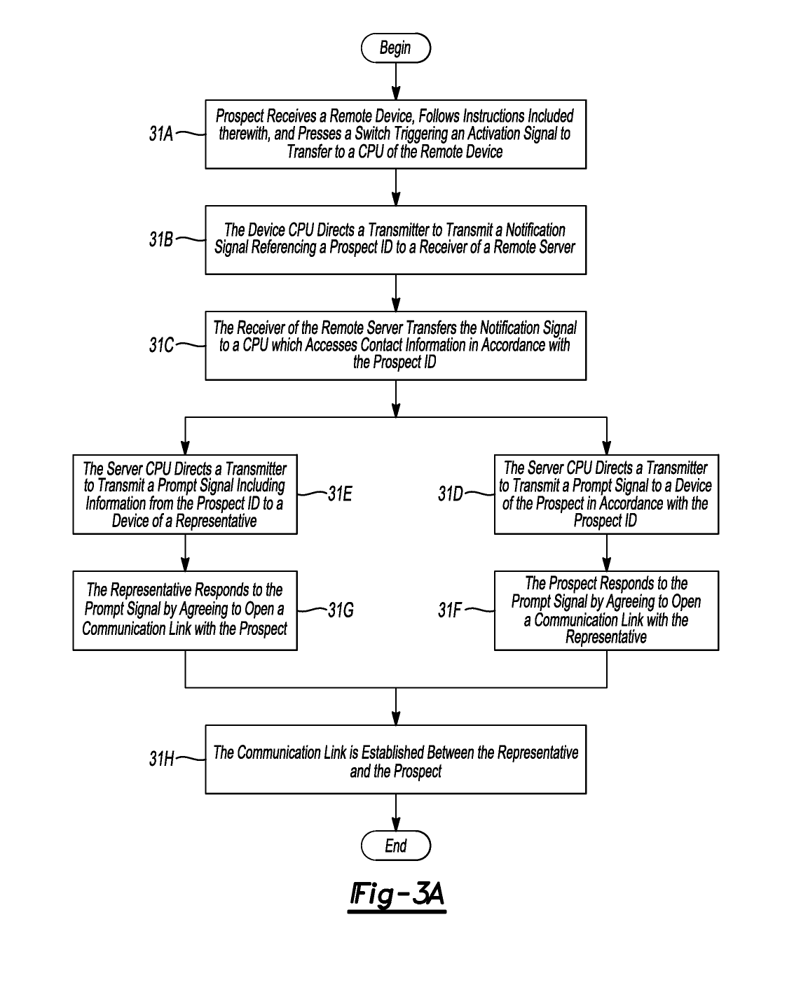

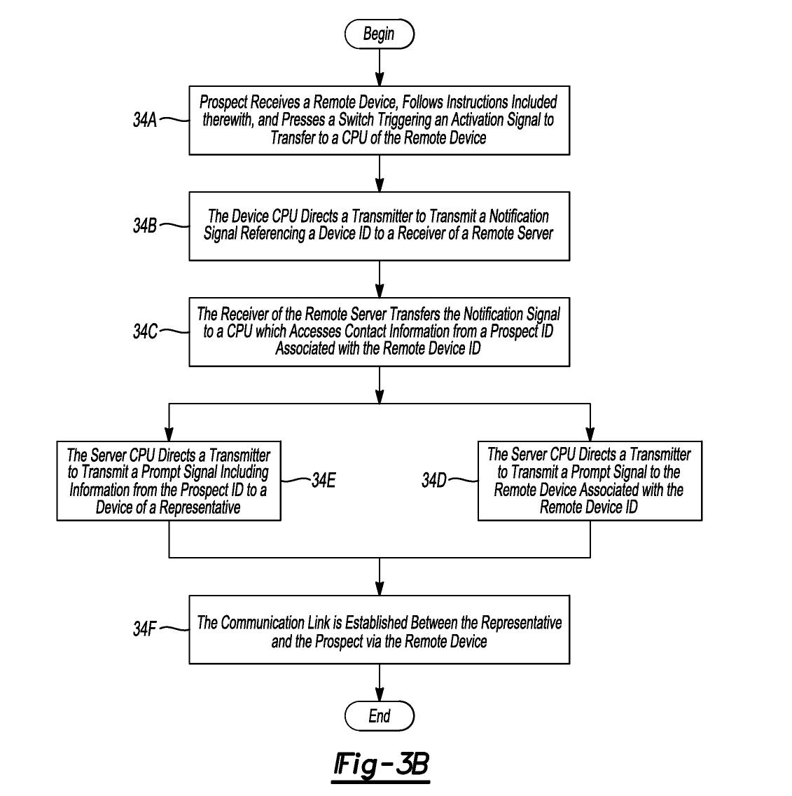

Now turning to the prospect contact phase and referring to block 31a of FIG. 3a, the remote device 10 may be delivered to the prospect in accordance with the contact information included with the prospect ID 29 and as part of a three-dimensional mailer (“3D mailer”) 30. Various designs and sizes may be available for the 3D mailer 30. In one example as shown in FIG. 2b, the 3D mailer 30 is approximately the size of a deck of cards and includes a secret agent theme further described below. The 3D mailer 30 may also include instructions describing activation of the remote device 10 which may invite the prospect to press a button on the remote device 10 if interested in receiving a marketing communication related to vendor goods and/or services. For example, a button or switch 32 may be included on the remote device 10 and in electrical communication with the device CPU 12. Pressing the switch 32 may send an activation signal to device CPU 12. As shown in block 31b, the device CPU 12 may receive the activation signal and transmit a notification signal to the remote server 11 via the transmitter 16 and receiver 22. A cellular network may be one example of a network which may assist in transferring the notification signal from the remote device 10 to the remote server 11. Reference to the prospect ID 29 may be included with the notification signal such that the remote server 11 may also identify the prospect to access the one or more digitally identifiable items relating to prospect ID 29 as shown in block 31c.

Optionally, a light emitting diode (“LED”) 33a may be included in the remote device 10. The device CPU 12 may include programming to trigger activation of the LED 33a when a communication link is available between the transmitter 16 and the receiver 22. The remote device 10 may also include a speaker 33b which may be used to output audio files stored on the memory 14 in accordance to instructions received from the device CPU 12. The remote device 10 may also include a microphone 33c in communication with the device CPU 12. The LED 33a, speaker 33b, and microphone 33c may further enhance the prospect's experience when interacting with the remote device 10.

Once the notification signal is received, the remote server 11 may begin to initiate the communication link completion phase between a representative of the vendor and the prospect. For example and now referring to block 31d, the remote server 11 may access the prospect's contact information from the prospect ID 29 and transmit a prompt signal to a prospect device such as a phone call to the prospect. Examples of the prospect device may include a cellular phone, tablet or PC in which case the prompt signals may also be short message service (“SMS”) or email communications. When the prospect answers the phone call, an automated message stored on the remote server 11 may play. The message may include an interactive menu to confirm the identity of the prospect and to confirm the prospect pressed the switch 32 to initiate generation of the marketing communication link. The automated message may also include instructions for terminating any further activity or deleting the prospect ID 29 from the remote server 11 in the event the prospect is contacted by mistake or does not wish to be contacted in the future.

Simultaneous to transmitting the prompt signal to the prospect, the remote server 11 may transmit a prompt signal to a representative device of the vendor such as a phone call to a vendor representative as shown in block 31e. Examples of the representative device may include cellular phones, tablets, and PCs in which case the prompt signals may also be SMS or email communications. When the representative answers the phone call, an automated message stored on the remote server 11 may play. The message may include information from the prospect ID 29 to prepare the representative for the marketing communication with the prospect. If the representative and prospect both respond to the automated messages with a desire to connect as shown in block 31f and 31g, the calls may be bridged to open the marketing communication link as shown in block 31h. The representative may then provide information relating to the vendors goods and/or services and coordinate further activities such as a sale and/or follow up communication. Optionally or alternatively, the timing of the prompt signal transmissions to the representative and prospect may be different if, for example, the representative may need time to prepare materials for discussion with the prospect during the communication link.

FIG. 3b shows another example of the prospect contact phase and the communication link completion phase. In block 34a, the remote device 10 may be delivered to the prospect in accordance with the contact information included with the prospect ID 29 and as part of the 3D mailer 30. The 3D mailer 30 may also include instructions describing activation of the remote device 10 which may invite the prospect to press a button on the remote device 10 if interested in receiving a marketing communication related to vendor goods and/or services via the remote device 10. For example, the button or switch 32 may be included on the remote device 10 and in electrical communication with the device CPU 12. Pressing the switch 32 may send an activation signal to device CPU 12. As shown in block 34b, the device CPU 12 may receive the activation signal and transmit a notification signal to the remote server 11 via the transmitter 16 and receiver 22. A cellular network may be one example of a network which may assist in transferring the notification signal from the remote device 10 to the remote server 11. Reference to the remote device ID 28 may be included with the notification signal such that the remote server 11 may also identify the prospect ID 29 associated with the remote device ID 28 to access the one or more digitally identifiable items as shown in block 34c.

Once the notification signal is received, the remote server 11 may begin to initiate the communication link completion phase between a representative of the vendor and the prospect. For example and now referring to block 34d, the remote server 11 may access the remote device ID 28 and transmit a prompt signal such as a call to the remote device 10. When the prospect answers the phone call on the remote device, the speaker 33b and microphone 33c may be activated.

Simultaneous to transmitting the prompt signal to the prospect, the remote server 11 may transmit a prompt signal to a representative device of the vendor such as a phone call to a vendor representative as shown in block 34e. When the representative and prospect both respond or answer their respective prompt signal or phone calls, the calls may be bridged to open the marketing communication link as shown in block 34f. The representative may then provide information relating to the vendors goods and/or services and coordinate further activities such as a sale and/or follow up communication. Optionally or alternatively, the timing of the prompt signal transmissions to the representative and prospect may be different if, for example, the representative may need time to prepare materials for discussion with the prospect during the communication link.

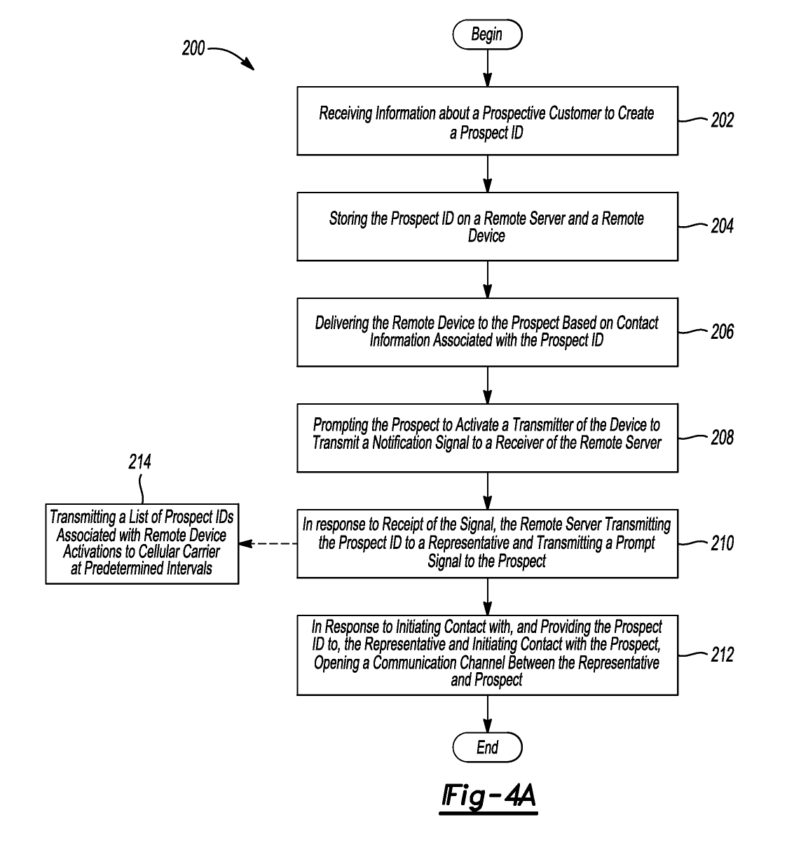

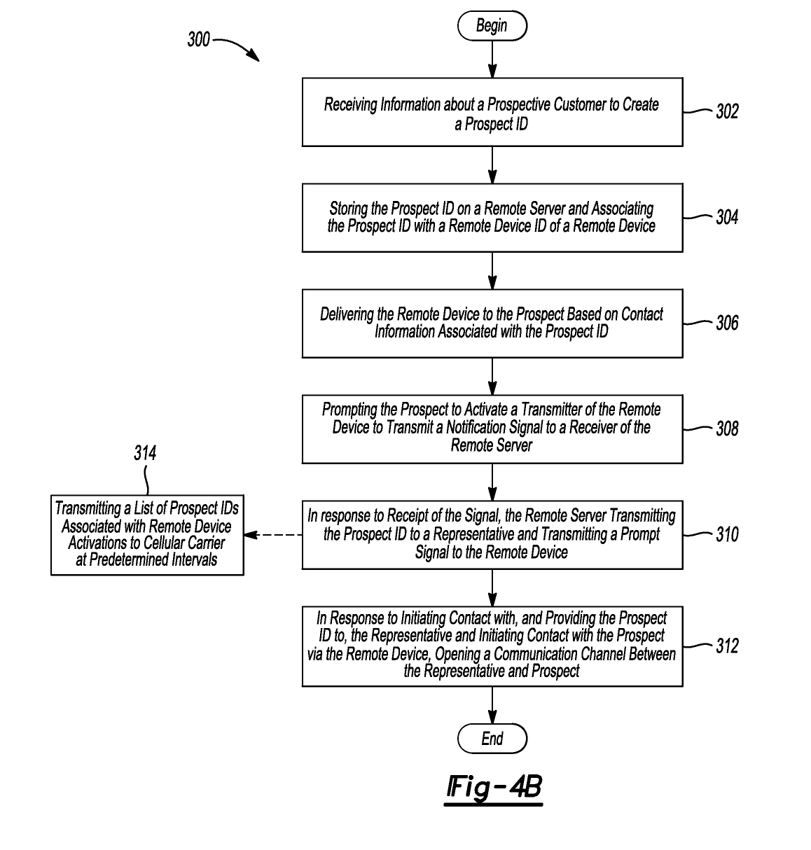

Referring now to FIG. 4a, a method for generating a marketing communication link is generally indicated by reference numeral 200. Operation 202 may include receiving a prospect ID having prospect information such as contact details along with prospect preferences related to vendor goods and/or services. In operation 204, the prospect ID may be uploaded to a remote server and a remote device. The remote device may be delivered to the prospect in accordance with the prospect ID in operation 206. For example, the remote device may be sent in a three-dimensional mailer including instructions for activating the remote device or the remote device may be distributed at a trade show. In operation 208, the prospect may be prompted to activate a transmitter of the remote device to transmit a signal to the remote server indicating a desire to generate a marketing communication link. The signal may also identify the related prospect ID. The transmitter may be activated by pressing a button or switch in communication with a CPU of the remote device. In response to receipt of the signal, the remote server may transmit a communication prompt with the prospect ID to the representative of the vendor and transmit a communication prompt to the prospect as shown in operation 210. For example, each may receive a phone call including an automated message which may include options to proceed further. In operation 212, the remote server may open the marketing communication link, such as bridging the calls between the representative and prospective customer.

Optionally, in operation 214 a list of prospect IDs associated with remote device activations may be transmitted to the network service provider, such as a cellular carrier, at predetermined intervals. The cellular carrier may deactivate service to the remote devices included on the list to prevent unintended use of the remote device. The list of prospect IDS associated with remote device activations may also be monitored by the marketing entity. The cellular carrier and/or marketing entity may deactivate service to the remote devices included on the list to prevent unintended use of the remote device.

Referring now to FIG. 4b, another method for generating a marketing communication link is generally indicated by reference numeral 300. Operation 302 may include receiving a prospect ID having prospect information such as contact details along with prospect preferences related to vendor goods and/or services. In operation 304, the prospect ID may be uploaded to a remote server and associated with a remote device ID of a remote device. The remote device may be delivered to the prospect in accordance with the prospect ID in operation 306. For example, the remote device may be sent in a three-dimensional mailer including instructions for activating the remote device or the remote device may be distributed at a trade show. In operation 308, the prospect may be prompted to activate a transmitter of the remote device to transmit a signal to the remote server indicating a desire to generate a marketing communication link. The signal may also identify the remote device ID. The transmitter may be activated by pressing a button or switch in communication with a CPU of the remote device. In response to receipt of the signal, the remote server may transmit a communication prompt with the prospect ID associated with the remote device ID to the representative of the vendor and transmit a communication prompt to the prospect via the remote device as shown in operation 310. For example, a microphone and speaker may activate on the remote device and the representative may receive a phone call. In operation 312, the remote server may open the marketing communication link, such as bridging the calls between the representative and prospective customer via the remote device.

Optionally, in operation 314 a list of prospect IDs associated with remote device activations may be transmitted to the network service provider, such as a cellular carrier, at predetermined intervals. The list of prospect IDs associated with remote device activations may also be monitored by the marketing entity. The cellular carrier and/or marketing entity may deactivate service to the remote devices included on the list to prevent unintended use of the remote device.

The 3D mailer 30 and remote device 10 may also include different themes, such as a secret agent theme, to engage the prospect as part of the marketing experience. For example, the 3D mailer 30 may be marked “Top Secret” and the remote device 10 may identified as an “Emergency Business Beacon.” The instructions in the 3D mailer may describe a mission in which the prospect may be thought of as an agent and the vendor may be thought of as a tactical operations center.

For example, the prospect may open the instructions and read: “Your mission, should you choose to accept it, is to grow your business by getting your product or service in front of the most potential customers when it is relevant to them. To aid you in your mission, our development labs have equipped you with the enclosed T9000 Emergency Business Beacon. With the press of a button, you will receive immediate assistance in your mission. The tactical operations center will make near instant contact with you, and help you discover how you can put your message in front of the right customers, right when they're searching for what you have to offer.” The prospect may then press the switch 32 on the remote device 10 to initiate the marketing communication link generation described above. Moments later or immediately thereafter, the prospect's phone may ring or the microphone and speaker of the remote device may activate and upon answering, the prospect may be provided with additional mission options, such as opening a communication link with the tactical operations center. If the prospect agrees to open the communication link, the call may be linked with the tactical operations center where the representative of the vendor may continue the secret agent theme while discussing current vendor promotions and/or while providing other marketing information. Other themes may be available to use with the 3D mailer 30 and remote device 10. For example, a farming theme or a mining theme.

While exemplary embodiments are described above, it is not intended that these embodiments describe all possible forms encompassed by the disclosure. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An electronic device for opening a marketing communication link between a marketer and a prospect comprising:
a housing including
a processor,
a transmitter in communication with the processor and configured to communicate with a receiver of a remote server,
a device ID associated with a prospect ID relating to the prospect receiving the device,
a switch in communication with the processor, and
a memory including software instructions executable by the processor and configured to direct the transmitter to transmit a notification signal including the device ID to the receiver of the remote server when the switch is triggered such that the marketing communication link is opened between the marketer and the prospect.

2. The electronic device of claim 1, further comprising a speaker and a microphone.

3. The electronic device of claim 2, further comprising a receiver, and wherein the transmitter and receiver are in communication with the microphone and speaker such that the communication link between the prospect and the marketer is facilitated by the electronic device.

4. The electronic device of claim 1, wherein the housing is a hand-held housing.

5. The electronic device of claim 4, wherein the housing has external surfaces suitable for printing of a marketing message.

6. A remote server for opening a marketing communication link comprising:
a receiver;
a transmitter;
a memory including a prospect ID including contact information of a prospect; and
a processor in communication with the receiver and the transmitter, the processor configured to process an activation signal received by the receiver from an electronic device and including a device ID associated with the prospect ID, and to access the prospect contact information and to direct the transmitter to transmit a signal to the electronic device based on the prospect contact information and to open a communication link between a marketer and the prospect.

7. The remote server of claim 6, wherein the processor is further configured to transmit a prompt signal to a media device of the prospect based on the prospect contact information.

8. The remote server of claim 6, wherein the processor is further configured to output media files accessible by the marketer and including marketing information relating to the prospect contact information.

9. The remote server of claim 6, wherein the processor is further configured to receive a message from a network service provider for deactivation consideration of the electronic device associated with the prospect ID based on activity or inactivity of the electronic device.

10. The remote server of claim 6, wherein the processor is further configured to communicate with a personal media device via a network such that a user may direct operations of the remote server.

11. A method of opening a marketing communication link comprising:
receiving a prospect ID and a device ID and uploading the prospect ID and device ID to a remote server;
delivering an electronic device to a prospect based on contact information associated with the prospect ID;
prompting the prospect to activate a transmitter of the electronic device to transmit a notification signal to a receiver of the remote server;
in response to receipt of the signal, the remote server transmitting (i) a signal with the prospect ID to a marketer, and (ii) another signal to the electronic device; and
in response to initiating contact with, and providing the prospect ID to, the marketer and initiating contact with the prospect via the electronic device, opening a communication link between the marketer and prospect.

12. The method of claim 11, wherein the opening of the communication link further comprises transmitting a signal to a media device associated with the prospect ID.

13. The method of claim 12, further comprising providing an opt-out or termination option for the prospect when the communication link is established.

14. The method of claim 11, further comprising delivering a message including the prospect ID to a network service provider for deactivation consideration based on activity or inactivity of the transmitter.

15. The method of claim 11, wherein the prospect ID comprises prospect preference information stored as one or more digitally identifiable items.

16. The method of claim 11, wherein the prospect ID is uniquely associated with the device ID.

17. The method of claim 11, wherein the electronic device is delivered to the prospect as part of a three-dimensional mailer.

18. The method of claim 11, wherein the electronic device further comprises a housing having external surfaces suitable for printing of a marketing message.

19. The method of claim 11, further comprising activating a light source or speaker to output a media signal in response to activating the transmitter of the electronic device.

20. The method of claim 11, wherein the opening of the communication link includes a theme selected to engage the prospect.
